(19) United States
(12) Patent Application Publication
(10) Pub. No.: US 2013/0220441 A1
(43) Pub. Date: Aug. 29, 2013

(54) VALVE

(71) Applicant: SPIRAX-SARCO LIMITED, (US)

(72) Inventor: Charles Zanettacci, Gloucestershire (GB)

(73) Assignee: SPIRAX-SARCO LIMITED, Gloucestershire (GB)

(21) Appl. No.: 13/774,146

(22) Filed: Feb. 22, 2013

(30) Foreign Application Priority Data
Feb. 24, 2012 (GB) 1203255.3

(51) Int. Cl. F16T 1/38; F16T 1/14

(52) U.S. Cl. CPC F16T 1/383; F16T 1/14
USPC 137/183; 251/359

(57) ABSTRACT

There is disclosed a valve comprising a valve body having an upper sealing surface and a maintainable seat detachably attached to the valve body and having a lower sealing surface. A gasket is disposed between the upper and lower sealing surfaces so as to provide a seal between the valve body and the maintainable seat. At least one of the sealing surfaces is profiled. This results in the gasket being highly-compressed so as to form an effective seal.

### CROSS-REFERENCE TO RELATED APPLICATIONS

The present application claims priority to GB 1203255.3 filed on 24 Feb. 2012, which is hereby incorporated by reference in its entirety for any and all purposes.

### BACKGROUND

The invention relates to a valve having a maintainable valve seat, in particular, although not exclusively, to a steam trap having a maintainable valve seat.

May different types of valves are used in fluid systems. One type of valve is known as a condensate trap and these are commonly used in steam systems, in which circumstances they are usually referred to as steam traps. Their function is to discharge condensed water from the system without allowing steam to escape. If steam is lost from the system, this represents a waste of energy. Steam traps thus commonly comprise a valve which is responsive to the presence of condensate or steam in the vicinity of the valve, so that the valve opens when condensate is present and closes when steam is present.

There are numerous different types of steam traps. One type of steam trap is known as a thermodynamic, or TD, steam trap. A thermodynamic steam trap comprises a trap body that defines a trap chamber, and a valve seat body disposed within the trap chamber having an inlet and an outlet. There is also provided a floating disc that serves as a valve member, mating with the valve seat to control fluid communication between the inlet and the outlet. When steam is first turned on, the disc is raised by the pressure, and air in the line is discharged. The cold condensate which follows is also discharged. As the condensate temperature and pressure rises, flash steam is formed under the disc and the velocity of this passing below the disc towards the outlet increases, lowering the pressure under the disc so that the disc is drawn towards the seat. At the extreme circumference of the disc, the velocity is less and there is a pressure build-up in the trap chamber above the disc until, at a point when the condensate temperature has approached that of steam, the flash-produced pressure in the trap chamber, acting on the large overall area of the disc, overcomes the inlet pressure (which acts on a smaller area of the disc) and the disc snaps shut against the seat rings to prevent further flow. Deprived of further flash steam, the temperature and pressure in the chamber above the disc falls, the inlet pressure asserts itself and the valve opens for the cycle to be repeated.

It is known to provide a steam trap, such as a thermodynamic steam trap, with a maintainable valve seat body that is detachably attached to the trap body. This allows the valve seat body to be removed and replaced in order to service the steam trap, without the need to replace the whole trap. In a previously considered arrangement, a profiled gasket, such as a kammprofile gasket, is disposed between the flat opposing faces of the trap body and the maintainable seat. This provides an effective seal between the trap body and the maintainable seat. Whilst such an arrangement is effective, profiled gaskets are relatively expensive.

It is therefore desirable to provide a valve having a maintainable seat with a sealing arrangement that is both effective and cost efficient.

### SUMMARY

In accordance with one aspect of the invention there is provided a valve, such as a steam trap, comprising: a valve body (or trap body in the case of a steam trap) having an upper (or first) sealing surface; a maintainable seat detachably attached to the valve body and having a lower (or second) sealing surface (which is opposed to the first sealing surface); and a gasket disposed between the upper (first) and lower (second) sealing surfaces so as to provide a seal between the valve body and the maintainable seat; wherein at least one of the sealing surfaces is profiled. The profile may comprise a plurality of ridges. The profile of the gasket causes the gasket to be highly compressed so as to provide an effective seal.

The gasket may be a plain gasket. The use of a plain gasket results in an overall cost reduction. The gasket may be deformable. The gasket may be substantially made from graphite.

Any suitable profile may be used providing that it can locally highly-compress the gasket. At least one of the sealing surfaces may have a corrugated profile. The corrugated profile may be a plurality (or series) of concentric corrugations (or ridges). The lower sealing surface may be profiled.

The maintainable seat may provide a valve seat for a valve member. The valve may further comprise a valve member arranged to cooperate with the valve seat. The valve seat may be the upper surface of the maintainable seat. An inlet passage and an outlet passage may extend through the maintainable seat and terminate at the valve seat providing an inlet port and an outlet port respectively. The valve seat may comprise an annular recess or channel into which the outlet passage opens. The inlet passage may terminate at the centre of the valve seat.

The valve body may comprise an inlet port and an outlet port which terminate at the upper sealing surface and which are aligned with the inlet passage and the outlet passage of the maintainable seat respectively so as to be in fluid communication therewith.

The gasket may comprise an inlet opening and an outlet opening which are aligned so as to permit fluid communication between the inlet port and the inlet passage, and the outlet port and the outlet passage.

The maintainable seat may be disposed within a valve chamber, at least a part of which is defined by the valve body.

The valve may be a control valve or a steam trap or a condensate trap, for example. The valve body may be a trap body. The valve may be a thermodynamic steam trap.

The invention also concerns a maintainable seat for use with a valve in accordance with any statement herein, wherein the lower sealing surface is profiled.

According to another aspect of the invention there is provided a maintainable seat for a valve, such as a steam trap, having a lower profiled sealing surface, wherein the maintainable seat is arranged to be detachably attached to a valve body having an upper sealing surface with a gasket disposed between the upper and lower sealing surfaces so as to provide a seal between the valve body and the maintainable seat.

According to yet another aspect of the invention there is provided a method of modifying an existing valve, such as a steam trap, having a valve body and a maintainable seat, comprising: removing the existing maintainable seat and gasket; and installing a maintainable seat in accordance with any statement herein with a new gasket disposed between the maintainable seat and the valve body.

The invention may comprise any combination of the features and/or limitations referred to herein, except combinations of such features as are mutually exclusive.

### BRIEF DESCRIPTION OF THE DRAWINGS

Embodiments of the invention will now be described, by way of example, with reference to the accompanying drawings, in which:

FIG. 1 schematically shows a cross-sectional view of a steam trap;

FIG. 2 schematically shows the maintainable valve seat body of FIG. 1;

FIG. 3 schematically shows a plan view of a gasket;

FIG. 4 schematically shows an enlarged view of the lower sealing surface of the maintainable seat of FIG. 2;

FIG. 5 schematically shows a cross-sectional view of a control valve; and

FIG. 6 schematically shows an enlarged view of the maintainable seat and valve body of FIG. 5.

### DETAILED DESCRIPTION

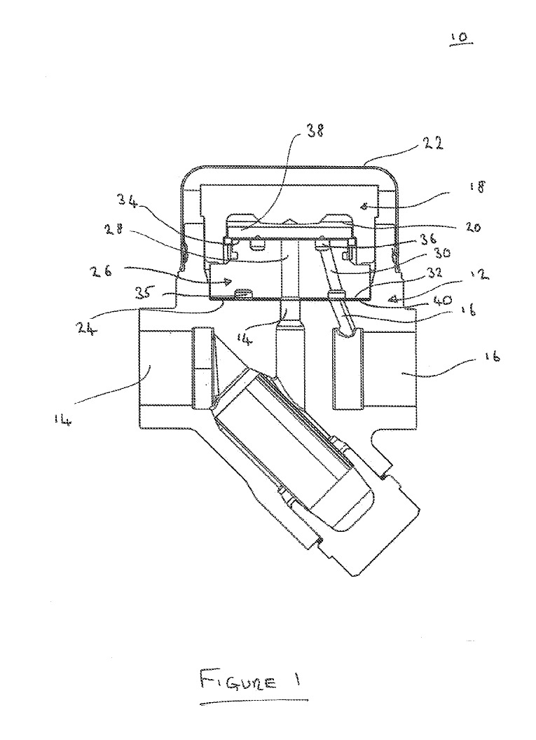

FIG. 1 shows generally at 10 a thermodynamic steam trap comprising a trap body 12 having an inlet port 14 and outlet port 16. The trap 10 further comprises a cap 18 which is threadedly attached to the trap body 12 to define a trap chamber 20 therebetween and a cover 22 which sits over the cap 18. The trap body 12 comprises an upper substantially planar surface 24 and the inlet port 14 and outlet port 16 terminate at this surface.

With reference to FIG. 2, the trap 10 further comprises a substantially cylindrical maintainable valve seat body 26 which is disposed within the trap chamber 20 and is seated on the upper surface 24 of the trap body 12. The maintainable seat 26 comprises an inlet passageway 28 and an outlet passageway 30 that each extend through the maintainable seat 26 from a lower surface 32 to an upper substantially circular valve seat 34. The inlet passageway 28 is aligned with the inlet port 14 and the outlet passageway 30 is aligned with the outlet port 16 such that there is fluid communication between them.

An annular groove 35, 36 is provided in both the lower and upper surfaces 32, 34 of the maintainable seat 26 and the outlet passageway 30 extends obliquely from the lower annular groove 35 and opens into the upper annular groove 36. The inlet passageway 28 is coaxial with the maintainable seat 26 and axially extends therethrough and opens into the centre of the valve seat 34. The lower annular groove 35 separates the lower surface 32 into two concentric lower sealing surfaces 32a, 32b (as described below), and the upper annular groove 36 separates the valve seat 34 into two concentric valve seat surfaces 34a, 34b.

Referring back to FIG. 1, the steam trap 10 also comprises a valve member 38 which is in the form of a disc. The valve member 38 is disposed above the maintainable seat 26 and is arranged to cooperate with the valve seat 34 to open and close the steam trap 10. When the valve member 38 is in contact with the valve seat 34 it is in the closed position and prevents fluid flow from the inlet 14 to the outlet 16. When the valve member 38 is raised from the valve seat 34 it is in an open position and allows fluid flow between the inlet 14 and outlet 16.

In use, the steam trap 10 is connected in a steam system with the inlet port 14 connected to a steam line and the outlet port 16 connected to a discharge. The steam trap 10 opens and closes so as to discharge condensate from the system.

The maintainable seat 26 is detachably attached to the trap body 12. This allows the steam trap 10 to be serviced by removing and replacing the maintainable seat 26. The maintainable seat 26 is held in place against the trap body 12 by the cap 18 which is threadedly attached to the trap body 12 and acts on a flange of the maintainable seat 26. In order for the steam trap 10 to operate correctly, it is important to provide a good seal between the upper (sealing) surface 24 of the trap body 12, and the lower (sealing) surface 32 of the maintainable seat 26. In particular, it is necessary to seal between the interface of the outlet port/passageway 16, 30 and the trap chamber 20; and the interfaces of the inlet port/passageway 14, 28, and the outlet port/passageway 16, 30. Accordingly, a plain graphite gasket (or seal) 40 is disposed between the upper sealing surface 24 and the lower sealing surface 32 of the trap body 12 and the maintainable seat 26 respectively. When the maintainable seat 26 is installed in the trap 10, the gasket 40 is compressed between the trap body 12 and the maintainable seat 26 by the cap 18 that is threadedly attached to the trap body 12 and acts on the maintainable seat 26. Thus, the gasket 40 can be tightly compressed by tightening the cap 18. As will be described in detail below, in order to provide a tight seal, at least one of the sealing surfaces 24, 32, in this case the lower sealing surface 32 of the maintainable seat 26, is profiled.

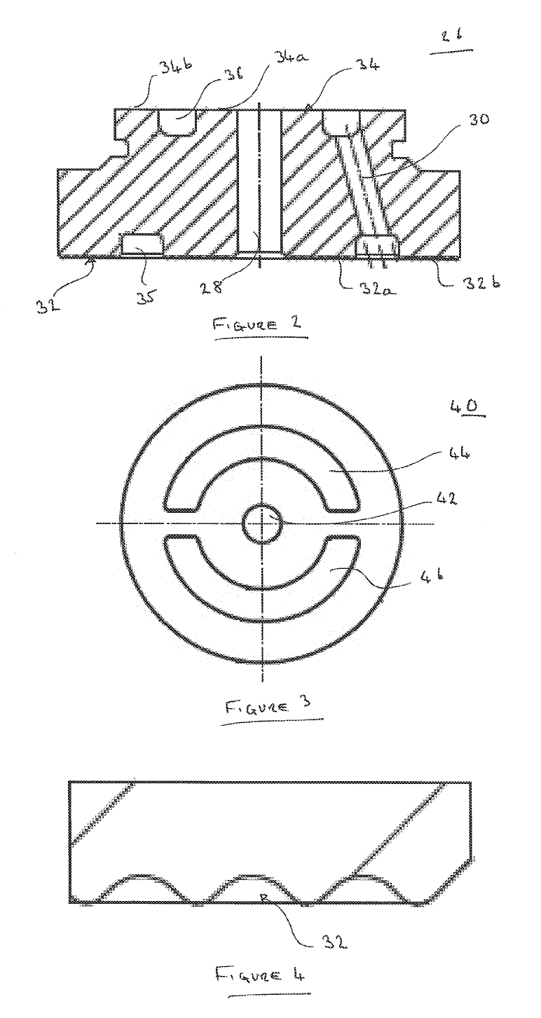

With reference to FIG. 3, the gasket 40 is substantially circular and comprises an inlet opening 42 that is located at the centre of the gasket 40, and first and second outlet openings 44, 46 that in the form of arcs. When the gasket 40 is disposed between the trap body 12 and the maintainable seat 26, the inlet opening 42 is aligned with the inlet port 14 and passageway 28, and one of the outlet openings 44, 46 is aligned with the outlet port 16 and passageway 30 so as to ensure fluid communication between the ports 14, 16 and passageways 28, 30.

As shown in FIG. 4, the entire lower sealing surface 34 (in other words both concentric rings 34a, 34b) has a corrugated profile. This means that when the gasket 40 is compressed between the trap body 12 and the maintainable seat 26 by the threaded cap 18, the gasket is highly compressed in the region of the corrugations, thereby providing a fluid tight seal. Specifically, by tightening the cap 18, the gasket 40 is highly compressed between the trap body 12 and the maintainable seat 26 in a first annular region between inlet port/passageway 14, 28 interface and the outlet port/passageway 16, 30 interface, and a second annular region between the outlet port/passageway 16, 30 interface and the edge of the maintainable seat 26. This prevents, or at least highly restricts, fluid flow leaking into the trap chamber 20, or leaking between the inlet and outlet 14, 16.

Although it has been described that the lower sealing surface 32 of the maintainable seat 26 is profiled, it should be appreciated that the upper sealing surface 24 of the trap body 12 could be profiled, or both sealing surfaces could be profiled.

The corrugated profile in this embodiment is a series of concentric corrugations. However, it should be appreciated that other suitable profiled surfaces could be used. The important feature of the profile is that it should be capable of locally highly-compressing the gasket so as to form a tight seal.

Although it has been described above that the invention is used in a steam trap, it should be appreciated that it could be applied to any valve having a maintainable seat, such as a control valve.

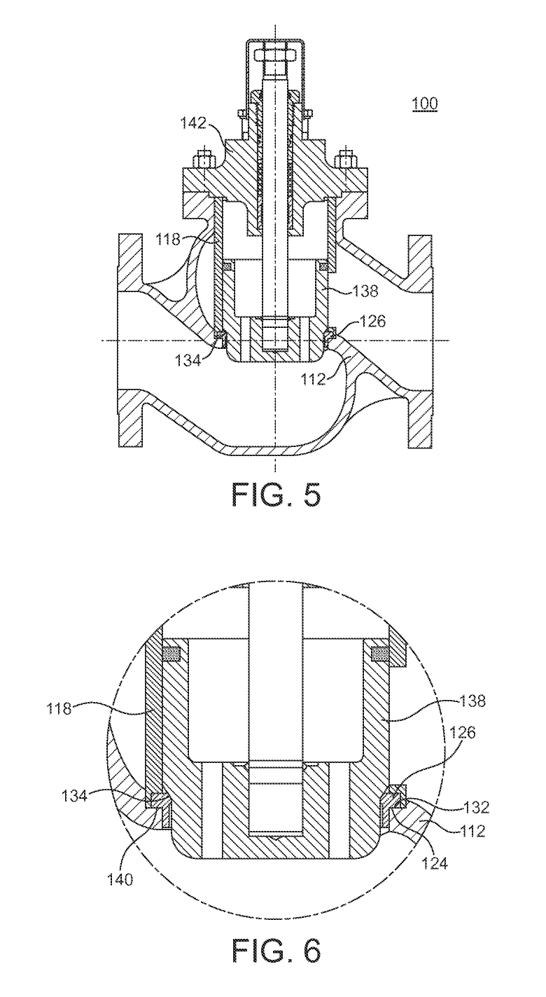

FIGS. 5 and 6 show a control valve 100 having a valve body 112, a maintainable seat body 126 detachably attached to the body 112, and a valve member (or plug) 138 that is arranged to cooperate with the valve seat 134 of the maintainable seat 126 so as to control the flow of fluid through the valve 100. The maintainable seat 126 has a lower sealing surface 132 and the valve body 112 has an opposing upper sealing surface 124. A plain graphite gasket 140 is disposed between these two surfaces 124, 132 so as to provide a seal between the valve body 112 and the maintainable seat 126. The maintainable seat 126 is axially held against the valve body 112 so as to tightly compress the gasket 140 by a sleeve 118 which acts on the maintainable seat 126 and is held in place by the bonnet 142 of the valve 100. As in the steam trap embodiment described above, one of the sealing surfaces 124, 132 is profiled with a series of concentric corrugations so as to locally high-compress the gasket 140, thus ensuring a tight seal. In this embodiment, the lower sealing surface 132 of the maintainable seat 126 is profiled. However, it should be appreciated that the upper sealing surface 124, or indeed both sealing surfaces, could be profiled.

1. A valve, comprising:
a valve body having an upper sealing surface;
a maintainable seat detachably attached to the valve body and having a lower sealing surface; and
a gasket disposed between the upper and lower sealing surfaces so as to provide a seal between the valve body and the maintainable seat;
wherein at least one of the sealing surfaces is profiled.

2. A valve according to claim 1, wherein the gasket is a plain gasket.

3. A valve according to claim 1, wherein the gasket is deformable.

4. A valve according to claim 1, wherein the gasket is substantially made from graphite.

5. A valve according to claim 1, wherein at least one of the sealing surfaces has a corrugated profile.

6. A valve according to claim 1, wherein the lower sealing surface is profiled.

7. A valve according to claim 1, wherein the maintainable seat provides a valve seat for a valve member.

8. A valve according to claim 7, further comprising a valve member configured to cooperate with the valve seat.

9. A valve according to claim 8, wherein an inlet passage and an outlet passage extend through the maintainable seat and terminate at the valve seat providing an inlet port and an outlet port respectively.

10. A valve according to claim 9, wherein the valve body comprises an inlet port and an outlet port which terminate at the upper sealing surface and which are aligned with the inlet passage and the outlet passage of the maintainable seat respectively so as to be in fluid communication therewith.

11. A valve according to claim 10, wherein the gasket comprises an inlet opening and an outlet opening which are aligned so as to permit fluid communication between the inlet port and the inlet passage, and the outlet port and the outlet passage.

12. A valve according to claim 1, wherein the maintainable seat is disposed within a valve chamber, at least a part of which is defined by the valve body.

13. A valve according to claim 1, wherein the valve is a steam trap or condensate trap, and wherein the valve body is a trap body.

14. A valve according to claim 13, wherein the valve is a thermodynamic steam trap.

15. A maintainable seat configured for use with a valve comprising:
a lower sealing surface configured to receive a gasket and further configured to be removably attachable with an upper sealing surface of a valve body of a valve such that the gasket is disposed between the upper and lower sealing surfaces so as to provide a seal between the valve body and the maintainable seat; and
wherein the lower sealing surface is profiled.

16. A valve, comprising:
a valve inlet and a valve outlet;
a valve chamber at least partially defined by a valve body having a valve body sealing surface;
a replaceable seat disposed within the valve chamber and detachably attached to the valve body such that it can be removed and replaced or repaired, wherein opposing sides of the replaceable seat have a seat sealing surface and a valve seat, wherein the seat sealing surface faces the valve body sealing surface, and wherein at least one of the valve body sealing surface and the seat sealing surface comprises corrugations;
a deformable gasket disposed between the valve body sealing surface and the seat sealing surface, wherein at least regions of the gasket are highly compressed between the valve body sealing surface and the seat sealing surface by the corrugations so as to provide a tight fluid seal between the valve body and the replaceable seat;
an inlet passageway and an outlet passageway in fluid communication with the valve inlet and the valve outlet respectively, each passageway extending through the valve body, the gasket and the replaceable seat and each terminating at the valve seat at an inlet port and an outlet port respectively; and
a valve member disposed within the valve chamber and configured to cooperate with the valve seat and moveable so as to be configured to open and close the valve by permitting or restricting fluid flow between the inlet port and the outlet port.
